(19) United States
(12) Patent Application Publication
(10) Pub. No.: US 2016/0105257 A1
(43) Pub. Date: Apr. 14, 2016

(54) DATA RECEIVING METHOD AND APPARATUS

(71) Applicant: HUAWEI TECHNOLOGIES CO., LTD., Shenzhen (CN)

(72) Inventors: Shurong JIAO, Shanghai (CN); Gengshi Wu, Shanghai (CN); Xiaolei Tie, Shanghai (CN)

(73) Assignee: HUAWEI TECHNOLOGIES CO., LTD., Shenzhen (CN)

(21) Appl. No.: 14/973,966

(22) Filed: Dec. 18, 2015

Related U.S. Application Data
(63) Continuation of application No. PCT/CN2014/079045, filed on Jun. 3, 2014.

(30) Foreign Application Priority Data
Jun. 19, 2013 (CN) 201310244772.5

(51) Int. Cl. H04L 1/00; H04B 1/7107; H04L 25/02; H04L 1/06

(52) U.S. Cl. CPC H04L 1/0048; H04L 1/0061; H04L 1/06; H04L 1/0026; H04B 1/71072; H04L 25/025

(57) ABSTRACT

The present invention provides a data receiving method and apparatus. The method includes: receiving a data signal delivered by a base station, where the data signal includes at least two encoded data block groups, and each encoded data block group includes at least one encoded data block; decoding the data signal, and acquiring decoded data blocks obtained by decoding the encoded data blocks; and separately performing CRC detection on each decoded data block, and determining, according to a CRC, obtained through detection, of each decoded data block, whether to execute an SIC operation, and if it is determined to execute an SIC operation, executing CRC detection again on the decoded data block on which an SIC operation is performed, until a same CRC result occurs or all CRCs are zero.

### CROSS-REFERENCE TO RELATED APPLICATIONS

This application is a continuation of International Application No. PCT/CN2014/079045, filed on Jun. 3, 2014, which claims priority to Chinese Patent Application No. 201310244772.5, filed on Jun. 19, 2013, both of which are hereby incorporated by reference in their entireties.

### TECHNICAL FIELD

The present invention relates to communications technologies, and in particular, to a data receiving method and apparatus.

### BACKGROUND

With the continuous development of communications technologies, a multiple-input and multiple-output (Multiple-input and Multiple-output, hereinafter referred to as MIMO for short) system is widely applied. Compared with a conventional single-antenna system, the MIMO system can greatly improve spectrum utilization, so that the system can transmit a data service with a higher rate in a limited wireless frequency band. That is, in the MIMO system, multiple transmit antennas and receive antennas are used at a transmit end and a receive end, respectively, and a signal is transmitted and received by using the multiple antennas at the transmit end and the receive end, thereby improving service quality for each user.

Specifically, in a four-branch (branch) MIMO system, a base station separately performs the following operations on four transport blocks (Transport Block, hereinafter referred to as TB for short) that are to be sent to a terminal, so as to form constellation point symbol streams: bit scrambling, code block segmentation, channel encoding, a physical layer hybrid automatic repeat request (Hybrid Automatic Repeat Request, hereinafter referred to as HARQ for short) function operation, physical code channel allocation, high-speed downlink shared channel (High-Speed Downlink Shared Channel, hereinafter referred to as HS-DSCH for short) interleaving, constellation point arrangement, channel mapping of physical code channels, and constellation point mapping. Interleaved data streams are obtained by performing inter-layer interleaving on the constellation point symbol streams, and spreading and scrambling, precoding, and summation of data of multi code channels are performed on the interleaved data streams, to finally generate signals corresponding to the transmit antennas. A specific inter-layer interleaving process is described in Table 1.

Subsequently, the terminal receives the signals sent by the antennas of the base station, and further processes the received signals to obtain original transport blocks. However, in the prior art, accuracy of the terminal in receiving downlink data of a four-branch MIMO system is relatively low, and the base station needs to bear unnecessary load.

### SUMMARY

Embodiments of the present invention provide a data receiving method and apparatus, which are used to resolve a problem in the prior art that accuracy of a terminal in receiving downlink data of a four-branch MIMO system is relatively low, and further reduce load of a base station.

A first aspect of the embodiments of the present invention provides a data receiving method, including:

receiving a data signal delivered by a base station, where the data signal includes at least two encoded data block groups, each encoded data block group includes at least one encoded data block, and encoded data blocks in each encoded data block group are transmitted in a binding manner;

decoding the data signal, and acquiring decoded data blocks obtained by decoding the encoded data blocks, to form corresponding decoded data block groups; and

separately performing cyclic redundancy check (CRC) detection on each decoded data block, and determining, according to a CRC, obtained through detection, of each decoded data block, whether to execute a successive interference cancellation (SIC) operation, and if it is determined to execute an SIC operation, executing CRC detection again on the decoded data block on which an SIC operation is performed, until a same CRC result occurs or all CRCs are zero, where

at least one of the determining to execute an SIC operation according to the CRC of each decoded data block includes: when CRCs of some decoded data blocks belonging to a decoded data block group are not zero, determining that the decoded data block is decoded incorrectly, and executing an SIC operation on the decoded data block.

With reference to the first aspect, in a first possible implementation manner of the first aspect, the determining, according to a CRC, obtained through detection, of each decoded data block, whether to execute an SIC operation includes:

identifying whether CRCs of all decoded data blocks are zero; and

when it is identified that the CRCs of all the decoded data blocks are all zero, determining that the decoded data blocks are decoded correctly, and skipping executing an SIC operation; or

when it is identified that not all of the CRCs of the decoded data blocks are zero, identifying whether a CRC result of each decoded data block is the same as a previous CRC result; and if the CRC result of each decoded data block is the same as the previous CRC result, determining that the decoded data block is decoded incorrectly, skipping executing an SIC operation, and reporting a retransmission indication to the base station, so that the base station resends a downlink data signal; or if the CRC result of each decoded data block is not the same as the previous CRC result, determining that the decoded data block is decoded incorrectly, and executing an SIC operation.

With reference to the first possible implementation manner of the first aspect, in a second possible implementation manner of the first aspect, the when it is identified that the CRC result of each decoded data block is not the same as a previous CRC result, determining that the decoded data block is decoded incorrectly, and executing an SIC operation includes:

when the CRC result of each decoded data block is not the same as the previous CRC result, separately performing a signal reconstruction operation on a decoded data block whose CRC is zero, to acquire a reconstructed signal of each decoded data block;

subtracting the reconstructed signal of each decoded data block from the received data signal, to acquire an original data signal corresponding to a decoded data block whose CRC is not zero;

performing a decoding preparation operation on the acquired original data signal; and

decoding the data signal on which the decoding preparation operation is performed, to obtain a decoded data block.

With reference to the second possible implementation manner of the first aspect, in a third possible implementation manner of the first aspect, the performing a decoding preparation operation on the acquired original data signal includes:

performing linear minimum mean square error (LMMSE) equalization, descrambling and despreading, inter-layer de-interleaving, and a log-likelihood ratio (LLR) calculation on the acquired original data signal.

With reference to the first aspect, in a fourth possible implementation manner of the first aspect, before the receiving a data signal delivered a base station, the method further includes:

separately acquiring physical channel quality corresponding to each encoded data block group, to determine an average CQI of each encoded data block group; and

reporting the average CQI to the base station, so that the base station determines, according to the average CQI, a size of the encoded data block of the delivered data signal.

With reference to any one of the first aspect to the fourth possible implementation manner of the first aspect, in a fifth possible implementation manner of the first aspect, if a quantity of the decoded data block groups is two, the decoding the data signal, and acquiring decoded data blocks includes:

decoding the data signal, and acquiring a first decoded data block group and a second decoded data block group, where the first decoded data block group includes: a first decoded data block and a fourth decoded data block, and the second decoded data block group includes: a second decoded data block and a third decoded data block, where the first decoded data block and the fourth decoded data block are transmitted in a binding manner, and the second decoded data block and the third decoded data block are transmitted in a binding manner.

With reference to the fifth possible implementation manner of the first aspect, in a sixth possible implementation manner of the first aspect, the separately performing CRC detection on each decoded data block, and determining, according to a CRC, obtained through detection, of each decoded data block, whether to execute a successive interference cancellation SIC operation, and if it is determined to execute an SIC operation, executing CRC detection again on the decoded data block on which an SIC operation is performed, until a same CRC result occurs or all CRCs are zero includes:

separately performing CRC detection on each decoded data block, to acquire the CRC of each decoded data block;

when it is identified that the first decoded data block group and the second decoded data block group each include a decoded data block whose CRC is not 0, performing an SIC operation for a first time on the decoded data blocks whose CRCs are not 0 in the first decoded data block group and the second decoded data block group;

performing CRC detection on the decoded data blocks on which the SIC operation is executed for the first time; and

if the CRCs of the decoded data blocks whose CRCs are not 0 in the first decoded data block group and the second decoded data block group are both 0 after undergoing the SIC operation for the first time, determining that the decoded data blocks are decoded correctly, and no longer executing an SIC operation;

if neither of the CRCs of the decoded data blocks on which the SIC operation is executed for the first time is 0, determining that the decoded data block is decoded incorrectly, no longer executing an SIC operation, and reporting a retransmission indication to the base station, so that the base station resends a downlink data signal; or

if the CRC of one of the decoded data blocks on which the SIC operation is executed for the first time is not 0, determining that the decoded data block is decoded incorrectly, and executing an SIC operation for a second time on the decoded data block whose CRC is not 0;

performing CRC detection on the decoded data block on which the SIC operation is executed for the second time; and

if the CRC of the decoded data block on which the SIC operation is executed for the second time is 0, determining that the decoded data block is decoded correctly, and no longer executing an SIC operation; or

if the CRC of the decoded data block on which the SIC operation is executed for the second time is not 0, determining that the decoded data block is decoded incorrectly, no longer executing an SIC operation, and reporting a retransmission indication to the base station, so that the base station resends a downlink data signal.

With reference to the fifth possible implementation manner of the first aspect, in a seventh possible implementation manner of the first aspect, the separately performing CRC detection on each decoded data block, and determining, according to a CRC, obtained through detection, of each decoded data block, whether to execute a successive interference cancellation SIC operation, and if it is determined to execute an SIC operation, executing CRC detection again on the decoded data block on which an SIC operation is performed, until a same CRC result occurs or all CRCs are zero includes:

separately performing CRC detection on each decoded data block, to acquire the CRC of each decoded data block;

when it is identified that all CRCs of decoded data blocks in one decoded data block group of the first decoded data block group and the second decoded data block group are all 0, and none of CRCs of decoded data blocks in the other decoded data block group is 0, performing an SIC operation for a first time on the decoded data blocks whose CRCs are not 0;

performing CRC detection on the decoded data blocks on which the SIC operation is executed for the first time; and

if the CRCs of all the decoded data blocks on which the SIC operation is executed for the first time are all 0, determining that the decoded data blocks are decoded correctly, and no longer executing an SIC operation;

if none of the CRCs of the decoded data blocks on which the SIC operation is executed for the first time is 0, determining that the decoded data block is decoded incorrectly, no longer executing an SIC operation, and reporting a retransmission indication to the base station, so that the base station resends a downlink data signal; or

if the CRC of one of the decoded data blocks on which the SIC operation is executed for the first time is not 0, executing an SIC operation for a second time on the decoded data block whose CRC is not 0; and

if the CRC of the decoded data block on which the SIC operation is executed for the second time is 0, determining that the decoded data block is decoded correctly, and no longer executing an SIC operation; or

if the CRC of the decoded data block on which the SIC operation is executed for the second time is not 0, determining that the decoded data block is decoded incorrectly, no longer executing an SIC operation, and reporting a retransmission indication to the base station, so that the base station resends a downlink data signal.

A second aspect of the embodiments of the present invention provides a data receiving apparatus, including:

a front-end receiving module, configured to receive a data signal delivered by a base station, where the data signal includes at least two encoded data block groups, each encoded data block group includes at least one encoded data block, and encoded data blocks in each encoded data block group are transmitted in a binding manner;

a decoding module, configured to decode the data signal, and acquire decoded data blocks obtained by decoding the encoded data blocks, to form corresponding decoded data block groups; and

an interference cancellation module, configured to: separately perform cyclic redundancy check (CRC) detection on each decoded data block, and determine, according to a CRC, obtained through detection, of each decoded data block, whether to execute a successive interference cancellation (SIC) operation, and if it is determined to execute an SIC operation, execute CRC detection again on the decoded data block on which an SIC operation is performed, until a same CRC result occurs or all CRCs are zero, where at least one of the determining to execute an SIC operation according to the CRC of each decoded data block includes: when CRCs of some decoded data blocks belonging to a decoded data block group are not zero, determining that the decoded data block is decoded incorrectly, and executing an SIC operation on the decoded data block.

With reference to the second aspect, in a first possible implementation manner of the second aspect, the interference cancellation module is specifically configured to: identify whether the CRC of each decoded data block is zero; and when it is identified that the CRCs of all the decoded data blocks are all zero, determine that the decoded data blocks are decoded correctly, and skip executing an SIC operation; or when it is identified that not all of the CRCs of the decoded data blocks are zero, identify whether a CRC result of each decoded data block is the same as a previous CRC result; and if the CRC result of each decoded data block is the same as the previous CRC result, determine that the decoded data block is decoded incorrectly, skip executing an SIC operation, and report a retransmission indication to the base station, so that the base station resends a downlink data signal; or if the CRC result of each decoded data block is not the same as the previous CRC result, determine that the decoded data block is decoded incorrectly, and execute an SIC operation.

With reference to the first possible implementation manner of the second aspect, in a second possible implementation manner of the second aspect, the interference cancellation module includes:

a signal re-constructor, configured to: when the CRC result of each decoded data block is not the same as the previous CRC result, separately perform a signal reconstruction operation on a decoded data block whose CRC is zero, to acquire a reconstructed signal of each decoded data block; and subtract the reconstructed signal of each decoded data block from the received data signal, to acquire an original data signal corresponding to a decoded data block whose CRC is not zero;

a decoding preparation unit, configured to perform a decoding preparation operation on the acquired original data signal; and

a decoder, configured to decode the data signal on which the decoding preparation operation is performed, to obtain a decoded data block.

With reference to the second possible implementation manner of the second aspect, in a third possible implementation manner of the second aspect, the decoding preparation unit is specifically configured to perform linear minimum mean square error (LMMSE) equalization, descrambling and despreading, inter-layer de-interleaving, and a log-likelihood ratio LLR on the acquired original data signal.

With reference to the second aspect, in a fourth possible implementation manner of the second aspect, the front-end receiving module further includes:

a CQI acquiring unit, configured to: before the data signal delivered by the base station is received, separately acquire physical channel quality corresponding to each encoded data block group, to determine an average CQI of each encoded data block group; and

an average CQI reporting unit, configured to report the average CQI to the base station, so that the base station determines, according to the average CQI, a size of the encoded data block of the delivered data signal.

With reference to any one of the second aspect to the fourth possible implementation manner of the second aspect, in a fifth possible implementation manner of the second aspect, if a quantity of the decoded data block groups is two, the decoding module is specifically configured to: decode the data signal, and acquire a first decoded data block group and a second decoded data block group, where the first decoded data block group includes: a first decoded data block and a fourth decoded data block, and the second decoded data block group includes: a second decoded data block and a third decoded data block, where the first decoded data block and the fourth decoded data block are transmitted in a binding manner, and the second decoded data block and the third decoded data block are transmitted in a binding manner.

In the method according to the embodiments of the present invention, a terminal receives a data signal delivered by a base station, acquires decoded data blocks from the data signal, performs CRC detection on each decoded data block, and determines, according to a CRC of each decoded data block, whether to execute an SIC operation, that is, when CRCs of some decoded data blocks belonging to a decoded data block group are not zero, the terminal performs an SIC operation at least once on the decoded data block whose CRC is not zero, and after performing the SIC operation, continues to perform CRC detection, until a same CRC result occurs or all CRCs are zero, thereby resolving a problem in the prior art that accuracy of the terminal in receiving downlink data of a four-branch multiple-input multiple-output system is relatively low, and further reducing load of the base station.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a schematic flowchart of Embodiment 1 of a data receiving method according to the present invention;

FIG. 2 is a schematic diagram of an application structure of a data receiving method of a MIMO system according to the present invention;

FIG. 3 is a schematic structural diagram of Embodiment 1 of a data receiving apparatus according to the present invention; and

FIG. 4 is a schematic structural diagram of Embodiment 2 of a data receiving apparatus according to the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

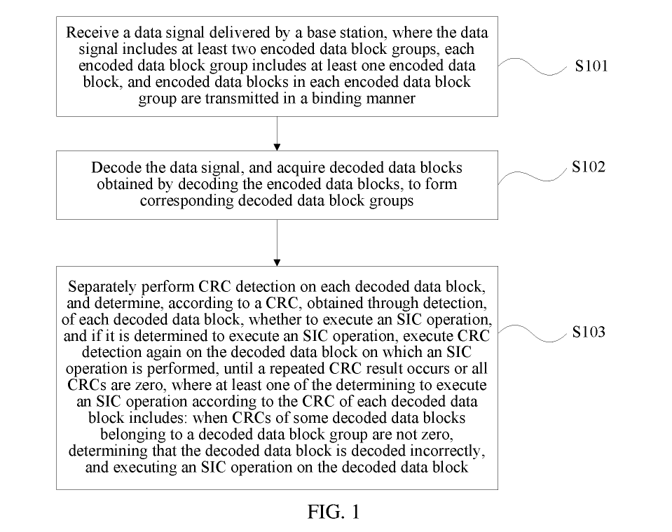

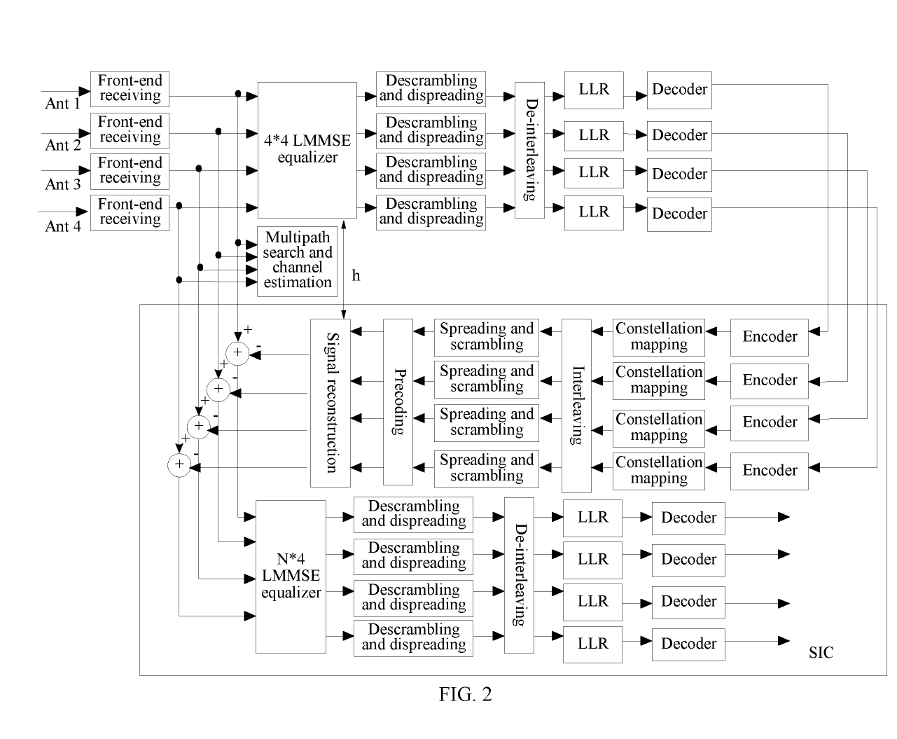

FIG. 1 is a schematic flowchart of Embodiment 1 of a data receiving method according to the present invention, and FIG. 2 is a schematic diagram of an application structure of a data receiving method of a MIMO system according to the present invention. The method of this embodiment is executed by a data receiving apparatus, and the apparatus may be integrated in a terminal. The method of this embodiment includes the following steps:

S101: Receive a data signal delivered by a base station, where the data signal includes at least two encoded data block groups, each encoded data block group includes at least one encoded data block, and encoded data blocks in each encoded data block group are transmitted in a binding manner.

S102: Decode the data signal, and acquire decoded data blocks obtained by decoding the encoded data blocks, to form corresponding decoded data block groups.

Specifically, the terminal receives, from an antenna end, a data signal delivered by a base station, where the data signal carries at least two encoded data block groups, each encoded data block group includes at least one encoded data block, and quantities of encoded data blocks in the encoded data block groups may be equal or may not be equal, which is not limited in the present invention. Encoded data blocks in each encoded data block group are transmitted in a binding manner, and each encoded data block has corresponding bit information (that encoded data blocks are transmitted in a binding manner herein actually refers that bit information on multiple encoded data blocks in an encoded data block group are transmitted together). As shown in FIG. 2, when the terminal receives the data signal delivered by the base station, a bit stream of the data signal enters a 4*4 linear minimum mean square error (Linear Minimum Mean Square Error, hereinafter referred to as LMMSE for short) equalizer for equalization, so as to remove interference from a receive end signal, so that a back end can better restore the originally sent signal; and then, the data signal on which equalization processing is performed enters a descrambling and despreading module and a de-interleaving module to be descrambled and despread and de-interleaved. Before the data signal is sent from a base station side, scrambling and spreading processing and inter-layer interleaving processing are performed on the data signal to avoid that a receive end cannot correctly restore the data signal because the data signal is interfered in a transmission process. Herein, the inter-layer interleaving is also used to avoid an occurrence of an error of consecutive “1s” or “0s” in bit information, and the interleaving is used to disperse and distribute these consecutive bits into the bit stream, so that the inter-layer de-interleaving can better restore the original data signal subsequently. A manner in which inter-layer interleaving is performed on the data signal is described in Table 1.1 (the inter-layer interleaving manner in Table 1.1 is described by using an example in which the terminal acquires four encoded data blocks). Therefore, corresponding descrambling and despreading processing and inter-layer de-interleaving processing need to be performed on the data signal on which equalization processing is performed, where the inter-layer de-interleaving manner is described in Table 1.2 (the inter-layer de-interleaving manner in Table 1.2 is described by using an example in which the terminal acquires four encoded data blocks), and an operation of performing inter-layer de-interleaving on received data is based on quantity information of encoded data blocks in a high speed shared control channel (High Speed Shared Control Channel, hereinafter referred to as HS-SCCH for short). FIG. 2 shows a structure of four decoders, but in an actual application, a quantity of actually working decoders is equal to a quantity of currently transmitted encoded data blocks, and the quantity of the currently transmitted encoded data blocks is determined by the base station according to channel state information (Channel State Information, hereinafter referred to as CSI for short) reported by the terminal, where the CSI includes a rank indicator (Rank Indicator, hereinafter referred to as RI for short), a precoding indicator (Precoding Indicator, hereinafter referred to as PCI for short), and a channel quality indicator (Channel Quality Indicator, hereinafter referred to as CQI for short); and in a four-branch MIMO system, the actual quantity of encoded data blocks is an integer ranging from 1 to 4. Further, the data signal on which the foregoing processing is performed enters a log-likelihood ratio (Log-Likelihood Ratio, hereinafter referred to as LLR for short) module and a decoder for further decoding processing, to acquire decoded data blocks obtained by decoding multiple encoded data blocks.

TABLE 1.1

| Quantity of transport blocks | Inter-layer interleaving output |
|---|---|
| 1 | x⁽⁰⁾ (i) = d⁽⁰⁾ (i) |
| 2 | x⁽⁰⁾ (i) = d⁽⁰⁾ (i) |
| | x⁽¹⁾ (i) = d⁽¹⁾ (i) |
| 3 | x⁽⁰⁾ (i) = d⁽⁰⁾ (i) |
| | ${x}^{( 1 )} ( i ) = \{ \begin{matrix}{d}^{( 1 )} ( i ) , & i is odd \\ {d}^{( 2 )} ( i ) , & i is even\end{matrix}$ |
| | ${x}^{( 2 )} ( i ) = \{ \begin{matrix}{d}^{( 2 )} ( i ) , & i is odd \\ {d}^{( 1 )} ( i ) , & i is even\end{matrix}$ |
| 4 | ${x}^{( 0 )} ( i ) = \{ \begin{matrix}{d}^{( 0 )} ( i ) , & i is odd \\ {d}^{( 3 )} ( i ) , & i is even\end{matrix}$ |
| | ${x}^{( 3 )} ( i ) = \{ \begin{matrix}{d}^{( 3 )} ( i ) , & i is odd \\ {d}^{( 0 )} ( i ) , & i is even\end{matrix}$ |
| | ${x}^{( 1 )} ( i ) = \{ \begin{matrix}{d}^{( 1 )} ( i ) , & i is odd \\ {d}^{( 2 )} ( i ) , & i is even\end{matrix}$ |
| | ${x}^{( 2 )} ( i ) = \{ \begin{matrix}{d}^{( 2 )} ( i ) , & i is odd \\ {d}^{( 1 )} ( i ) , & i is even\end{matrix}$ |

TABLE 1.2

| Quantity of transport blocks | Inter-layer interleaving output |
|---|---|
| 1 | d⁽⁰⁾ (i) = x⁽⁰⁾ (i) |
| 2 | d⁽⁰⁾ (i) = x⁽⁰⁾ (i) |
| | d⁽¹⁾ (i) = x⁽¹⁾ (i) |
| 3 | d⁽⁰⁾ (i) = x⁽⁰⁾ (i) |
| | ${d}^{( 1 )} ( i ) = \{ \begin{matrix}{x}^{( 1 )} ( i ) , & i is odd \\ {x}^{( 2 )} ( i ) , & i is even\end{matrix}$ |
| | ${d}^{( 2 )} ( i ) = \{ \begin{matrix}{x}^{( 2 )} ( i ) , & i is odd \\ {x}^{( 1 )} ( i ) , & i is even\end{matrix}$ |
| 4 | ${d}^{( 0 )} ( i ) = \{ \begin{matrix}{x}^{( 0 )} ( i ) , & i is odd \\ {x}^{( 3 )} ( i ) , & i is even\end{matrix}$ |
| | ${d}^{( 3 )} ( i ) = \{ \begin{matrix}{x}^{( 3 )} ( i ) , & i is odd \\ {x}^{( 0 )} ( i ) , & i is even\end{matrix}$ |
| | ${d}^{( 1 )} ( i ) = \{ \begin{matrix}{x}^{( 1 )} ( i ) , & i is odd \\ {x}^{( 2 )} ( i ) , & i is even\end{matrix}$ |
| | ${d}^{( 2 )} ( i ) = \{ \begin{matrix}{x}^{( 2 )} ( i ) , & i is odd \\ {x}^{( 1 )} ( i ) , & i is even\end{matrix}$ |

S103: Separately perform cyclic redundancy check (Cyclic Redundancy Check, hereinafter referred to as CRC for short) detection on each decoded data block, and determine, according to a CRC, obtained through detection, of each decoded data block, whether to execute a successive interference cancellation (Successive Interference Cancellation, hereinafter referred to as SIC for short) operation, and if it is determined to execute an SIC operation, execute CRC detection again on the decoded data block on which an SIC operation is performed, until a same CRC result occurs or all CRCs are zero, where at least one of the determining to execute an SIC operation according to the CRC of each decoded data block includes: when CRCs of some decoded data blocks belonging to a decoded data block group are not zero, determining that the decoded data block is decoded incorrectly, and executing an SIC operation on the decoded data block.

Specifically, the terminal performs CRC detection on each acquired decoded data block by using a CRC detection mechanism of the terminal, and determines, according to a CRC of each decoded data block, whether to execute an SIC operation, and if it is determined to execute an SIC operation, executes CRC detection again on the decoded data block on which an SIC operation is performed, until a same CRC result occurs or all CRCs are zero, where at least one of the determining to execute an SIC operation according to the CRC of each decoded data block includes: when CRCs of some decoded data blocks belonging to a decoded data block group are not zero, determining that the decoded data block is decoded incorrectly, and executing an SIC operation on the decoded data block. Herein, for example, the terminal acquires two decoded data block groups from the received data signal, where one decoded data block group includes one decoded data block, and the other decoded data block group includes two decoded data blocks:

The terminal acquires two decoded data block groups from the received data signal, which are separately a first decoded data block group and a second decoded data block group, where the first decoded data block group includes a first decoded data block obtained by decoding a first encoded data block, and the second decoded data block group includes a second decoded data block obtained by decoding a second encoded data block and a third decoded data block obtained by decoding a third encoded data block. Assuming that the terminal detects, by using the CRC detection mechanism of the terminal, that a CRC of the first decoded data block in the first decoded data block group is zero, and neither a CRC of the second decoded data block in the second decoded data block group nor a CRC of the third decoded data block in the second decoded data block group is zero, the terminal determines to perform an SIC operation on the two decoded data blocks in the second decoded data block group, that is, performs signal reconstruction on the decoded data block in the first decoded data block group and then subtracts the first decoded data block from an original data signal, performs corresponding operations on the remaining two decoded data blocks in the second decoded data block group, and performs CRC detection again on the second decoded data block and the third decoded data block on which an SIC operation is performed for a first time. Generally, after the SIC operation is performed for the first time on the two decoded data blocks in the second decoded data block group, there exist three cases, which are separately as follows: (1) The CRCs of both the second decoded data block and the third decoded data block are zero; (2) Neither of the CRCs of the second decoded data block and the third decoded data block is zero; and (3) The CRC of one of the decoded data blocks in the second decoded data block group is not zero, and herein it is assumed that the CRC of the third decoded data block is not zero. For the foregoing first and second cases, the terminal no longer performs an SIC operation; if it is the foregoing third case, the terminal continues to perform an SIC operation for a second time on the third decoded data block, and performs CRC detection on the third decoded data block on which the SIC operation is performed for the second time. If after the SIC operation is performed for the second time, the CRC of the third decoded data block is still not zero, the terminal no longer performs an SIC operation; and if after the SIC operation is performed for the second time, the CRC of the third decoded data block is zero, the terminal determines that the third decoded data block is decoded correctly, and the downlink data is received successfully.

In the prior art, in a case that is the same as the foregoing case, that is, if a terminal acquires two decoded data block groups from the received data signal, which are separately: a first decoded data block group and a second decoded data block group, where the first decoded data block group includes a first decoded data block obtained by decoding a first encoded data block, and the second decoded data block group includes a second decoded data block obtained by decoding a second encoded data block and a third decoded data block obtained by decoding a third encoded data block, assuming that the terminal detects, by using a CRC detection mechanism of the terminal, that a CRC of the first decoded data block in the first decoded data block group is zero, and neither a CRC of the second decoded data block in the second decoded data block group nor a CRC of the third decoded data block in the second decoded data block group is zero, the terminal performs an SIC operation for a first time on the two decoded data blocks in the second decoded data block group, and performs CRC detection again on the two decoded data blocks on which the SIC operation is performed for the first time. There also exist three cases, which are separately as follows: (1) The CRCs of both the second decoded data block and the third decoded data block are zero; (2) Neither of the CRCs of the second decoded data block and the third decoded data block is zero; (3) The CRC of one of the decoded data blocks in the second decoded data block group is not zero. For the two cases in which the CRCs of both the second decoded data block and the third decoded data block are zero, and neither of the CRCs of the second decoded data block and the third decoded data block is zero, the terminal also no longer performs an SIC operation. However, for the case in which the CRC of one of the decoded data blocks in the second decoded data block group is not zero, the terminal still considers that both of the two decoded data blocks are decoded incorrectly, and no longer performs an SIC operation for a second time; and instead, directly reports a retransmission indication to the base station, so that the base station re-delivers a data signal, which undoubtedly brings unnecessary load to the base station, and decoding accuracy of the decoded data block is also not high. However, in the present invention, in the foregoing case (3) in which the CRC of one of the decoded data blocks in the second decoded data block group is not zero, the terminal still performs an SIC operation for a second time on the decoded data block whose CRC is not zero, thereby ensuring accuracy of further decoding of the decoded data block, and also lightening load of the base station.

In the method according to this embodiment of the present invention, a terminal receives a data signal delivered by a base station, acquires decoded data blocks from the data signal, performs CRC detection on each decoded data block, and determines, according to a CRC of each decoded data block, whether to execute an SIC operation, that is, when CRCs of some decoded data blocks belonging to a decoded data block group are not zero, the terminal performs an SIC operation at least once on the decoded data block whose CRC is not zero, and after performing the SIC operation, continues to perform CRC detection, until a same CRC result occurs or all CRCs are zero, thereby resolving a problem in the prior art that accuracy of the terminal in receiving downlink data is relatively low, and further reducing load of the base station.

In Embodiment 2 of the present invention, on a basis of the foregoing Embodiment 1, preferably, the determining, according to a CRC, obtained through detection, of each decoded data block, whether to execute an SIC operation includes: identifying whether CRCs of all decoded data blocks are zero; and when it is identified that the CRCs of all the decoded data blocks are all zero, determining that the decoded data blocks are decoded correctly, and skipping executing an SIC operation; or when it is identified that not all of the CRCs of the decoded data blocks are zero, identifying whether a CRC result of each decoded data block is the same as a previous CRC result; and if yes, determining that the decoded data block is decoded incorrectly, skipping executing an SIC operation, and reporting a retransmission indication to the base station, so that the base station resends a downlink data signal; or if no, determining that the decoded data block is decoded incorrectly, and executing an SIC operation

Specifically, after acquiring each decoded data block, the terminal identifies, by using the CRC detection mechanism, whether CRCs of all decoded data blocks are zero. When it is identified that the CRCs of all the decoded data blocks are all zero, the terminal determines that the decoded data blocks are decoded correctly, and receives downlink data successfully and skips executing an SIC operation. A process after the correct decoding may be executed according to the prior art. When it is identified that not all of the CRCs of the decoded data blocks are zero, the terminal identifies whether a CRC result of each decoded data block is the same as a previous CRC result; and when it is identified that the CRC result of each decoded data block is the same as the previous CRC result, determines that the decoded data block is decoded incorrectly, skips executing the SIC operation, and reports a retransmission indication to the base station, so that the base station resends a downlink data signal. For the example in the foregoing Embodiment 1, neither of the CRCs of the two decoded data blocks in the second decoded data block group on which decoding is performed is zero, if both the two CRCs are still not zero after the SIC operation is performed for the first time, the terminal determines that the decoded data blocks are decoded incorrectly, skips executing an SIC operation, and reports a retransmission indication to the base station, so that the base station resends a downlink data signal; or when it is identified that the CRC result of each decoded data block is not the same as the previous CRC result, the terminal determines that the decoded data block is decoded incorrectly, and executes an SIC operation. Herein, another example is used for description, that is, assuming that the terminal acquires, from the received data signal, two decoded data block groups, which are separately a first decoded data block group and a second decoded data block group, where the first decoded data block group includes two decoded data blocks obtained by decoding data blocks, which are separately: a first decoded data block and a fourth decoded data block, the second decoded data block group includes two decoded data blocks obtained by decoding data blocks, which are separately a second decoded data block and a third decoded data block, CRCs of the first decoded data block and the second decoded data block are zero, and CRCs of the fourth decoded data block and the third decoded data block are not zero. In the prior art, a terminal directly considers that neither of the CRCs of the decoded data blocks in the first decoded data block group and the second decoded data block group is zero, and skips executing an SIC operation; instead, the terminal directly reports a retransmission indication to the base station, so that the base station re-delivers a data signal. However, in the present invention, the terminal still performs an SIC operation on the decoded data blocks whose CRCs are not zero in the first decoded data block group and the second decoded data block group, thereby ensuring decoding accuracy, and further lightening load of the base station.

In Embodiment 3 of the present invention, on a basis of the foregoing Embodiment 2, preferably, the when it is identified that the CRC result of each decoded data block is not the same as the previous CRC result, determining that the decoded data block is decoded incorrectly, and executing an SIC operation includes: when the CRC result of each decoded data block is not the same as the previous CRC result, separately performing a signal reconstruction operation on a decoded data block whose CRC is zero, to acquire a reconstructed signal of each decoded data block; subtracting the reconstructed signal of each decoded data block from the received data signal, to acquire an original data signal corresponding to a decoded data block whose CRC is not zero; performing a decoding preparation operation on the acquired original data signal; and decoding the data signal on which the decoding preparation operation is performed, to obtain a decoded data block.

Specifically, after acquiring the decoded data blocks, the terminal performs CRC detection on these decoded data blocks, and when a CRC result of each decoded data block is not the same as the previous CRC result, separately performs a signal reconstruction operation on a decoded data block whose CRC is zero, to acquire a reconstructed signal of each decoded data block. In actual application, the terminal reconstructs only information bits in the decoded data block whose CRC is zero. Referring to the structure shown in FIG. 2, encoding, constellation mapping, inter-layer interleaving, spreading and scrambling, and precoding operations are performed on the information bits that correspond to the decoded data block, where the inter-layer interleaving manner is described in Table 1.1; then, the reconstructed signal of each decoded data block is subtracted from the received signal, where only an original data signal corresponding to the decoded data block whose CRC is not 0 is reserved, and a decoding preparation operation is performed on the acquired original data signal. It should be noted that, in FIG. 2, after the terminal executes the signal reconstruction operation, a signal of a transmit end of the base station is actually reconstructed, and then, in combination with channel quality obtained through multipath searching and channel estimation, an original data signal corresponding to the decoded data block whose CRC is zero is constructed, where h in FIG. 2 is a value of channel estimation, representing the channel quality. The decoding preparation operation includes: performing LMMSE equalization, descrambling and despreading, inter-layer de-interleaving, and LLR operations on the acquired original data signal. In FIG. 2, before the information bits of each decoded data block enter an input end of an interleaving module, the terminal sets a data stream corresponding to the decoded data block whose CRC is not 0 to 0, and then interleaves the decoded data block with the decoded data block whose CRC is zero in a corresponding decoded data block group.

Further, the LMMSE equalization in the decoding preparation operation uses n×4, where n is determined according to a quantity of data streams actually existing in the received signal. For example, if 4 encoded data blocks are received, and after demodulation and decoding are performed for a first time on the 4 encoded data blocks, two encoded data blocks are decoded correctly, that is, after the two encoded data blocks are decoded, two corresponding decoded data blocks are correct, a reconstructed signal corresponding to the two decoded data blocks is subtracted from the received signal, where only a signal corresponding to the other two decoded data blocks remains in the received signal, so that n is 2 herein, that is, 2×4 LMMSE equalization is used. Subsequently, descrambling and despreading, inter-layer de-interleaving, LLR, and decoding operations are performed on the decoded data blocks on which equalization processing is performed, to acquire correct downlink data, where the inter-layer de-interleaving manner is described in Table 1.2.

After the foregoing operations are completed, the data signal on which the decoding preparation operation is performed is decoded, to obtain a decoded data block.

In Embodiment 4 of the present invention, preferably, before the receiving a data signal delivered by a base station, the method further includes: separately acquiring physical channel quality corresponding to each encoded data block group, to determine an average CQI of each encoded data block group; and reporting the average CQI to the base station, so that the base station determines, according to the average CQI, a size of the encoded data block of the delivered data signal.

Specifically, before the terminal receives the data signal delivered by the base station, the terminal separately acquires physical channel quality corresponding to each encoded data block group. Generally, in a data transmission process, information bits of encoded data blocks in each encoded data block group are generally transmitted together in a mixed manner, and occupy multiple physical channels, that is, each physical channel may have information bits of multiple different encoded data blocks, and each physical channel is corresponding to one CQI. Therefore, during transmission, each encoded data block group is corresponding to multiple CQIs. After acquiring the multiple CQIs corresponding to each encoded data block group, the terminal performs an averaging calculation on the acquired CQIs, to determine an average CQI of each encoded data block group, where the averaging may be arithmetic averaging, or may be another averaging manner such as statistical averaging. In addition, another manner may also be used to determine an average CQI of each encoded data block group, that is, acquiring signal to noise ratios of multiple physical channels occupied by each encoded data block group, averaging the signal to noise ratios to obtain an average signal to noise ratio, and further determining an average CQI by using the average signal to noise ratio, where the averaging may be arithmetic averaging, or may be another averaging manner such as statistical averaging. Further, after determining the average CQI corresponding to each encoded data block group, the terminal reports the average CQI of each encoded data block group to the base station, and the base station learns, according to the average CQI reported by the terminal, the physical channel quality corresponding to the encoded data block group, and determines the size of the encoded data block delivered to the physical channels. Herein, two encoded data block groups are used as an example. The two encoded data block groups are separately a first encoded data block group and a second encoded data block group, where the first encoded data block group includes a first encoded data block and a fourth encoded data block, and the second encoded data block group includes a second encoded data block and a third encoded data block. After inter-layer interleaving is performed on the data signal at the base station side, the first encoded data block and the fourth encoded data block are evenly distributed on a first layer and a fourth layer (where the layer may be a physical channel, or may be another channel for transmitting these encoded data blocks, which is not limited herein), that is, the first layer carries both the first encoded data block and the fourth encoded data block, and the fourth layer carries both the fourth encoded data block and the first encoded data block. The second encoded data block and the third encoded data block are also evenly distributed on the second layer and the third layer. In this case, the terminal separately acquires a first CQI and a fourth CQI, and/or, a second CQI and a third CQI by using a detection mechanism of the terminal, where the first CQI is a CQI of the first layer, the second CQI is a CQI of the second layer, the third CQI is a CQI of the third layer, and the fourth CQI is a CQI of the fourth layer. A first average CQI is determined according to the first CQI and the fourth CQI, and a second average CQI is determined according to the second CQI and the third CQI. Then, the terminal reports the first average CQI and/or the second average CQI to the base station, so that the base station delivers a data signal according to the first average CQI and/or the second average CQI. Because the first average CQI reported by the terminal is relatively close to a CQI of a channel through which the first encoded data block and the fourth encoded data block actually pass, and/or, the second average CQI is relatively close to a channel through which the second encoded data block and the third encoded data block actually pass, when delivering the data signal according to the first average CQI and/or the second average CQI, the base station learns a situation of the channels through which the encoded data blocks actually pass, and further delivers a data signal adaptive to the size of the encoded data block. If the first average CQI and/or the second average CQI are/is not reported, herein assuming that the first average CQI is not reported, if a relatively small CQI is reported to the base station, but the CQI is greater than the fourth CQI of the fourth layer and less than the first CQI of the first layer, a probability that the fourth encoded data block is decoded incorrectly is relatively high. However, the first layer may originally decode a larger encoded data block, but because the base station delivers data according to the smaller CQI, the first layer is not fully used, so that the base station does not deliver the data signal according to an actual channel situation, so that a capability of the terminal in receiving data is not adaptive to an amount of data delivered by the base station, thereby reducing a throughput for a user.

In the method according to this embodiment, the terminal reports an average CQI, so that the base station delivers data of an adaptive size to the terminal according to the average CQI, so that resources are fully utilized, thereby further improving a throughput for a user.

To make the technical solutions of the embodiments of the present invention clearer, herein, two decoded data block groups are used as an example Preferably, the decoding the data signal, and acquiring decoded data blocks includes: decoding the data signal, and acquiring a first decoded data block group and a second decoded data block group, where the first decoded data block group includes: a first decoded data block and a fourth decoded data block, and the second decoded data block group includes: a second decoded data block and a third decoded data block, where the first decoded data block and the fourth decoded data block are transmitted in a binding manner, and the second decoded data block and the third decoded data block are transmitted in a binding manner.

In Embodiment 5 of the present invention, on a basis of the foregoing embodiment, preferably, the separately performing CRC detection on each decoded data block, and determining, according to a CRC, obtained through detection, of each decoded data block, whether to execute a successive interference cancellation SIC operation, and if it is determined to execute an SIC operation, executing CRC detection again on the decoded data block on which an SIC operation is performed, until a same CRC result occurs or all CRCs are zero includes: separately performing CRC detection on each decoded data block, to acquire the CRC of each decoded data block; when it is identified that the first decoded data block group and the second decoded data block group each include a decoded data block whose CRC is not 0, performing an SIC operation for a first time on the decoded data blocks whose CRCs are not 0 in the first decoded data block group and the second decoded data block group; performing CRC detection on the decoded data blocks on which the SIC operation is executed for the first time; and if the CRCs of the decoded data blocks whose CRCs are not 0 in the first decoded data block group and the second decoded data block group are both 0 after undergoing the SIC operation for the first time, determining that the decoded data blocks are decoded correctly, and no longer executing an SIC operation; if neither of the CRCs of the decoded data blocks on which the SIC operation is executed for the first time is 0, determining that the decoded data blocks are decoded incorrectly, no longer executing an SIC operation, and reporting a retransmission indication to the base station, so that the base station resends a downlink data signal; or if the CRC of one of the decoded data blocks on which the SIC operation is executed for the first time is not 0, determining that the decoded data block is decoded incorrectly, and executing an SIC operation for a second time on the decoded data block whose CRC is not 0; performing CRC detection on the decoded data block on which the SIC operation is executed for the second time; and if the CRC of the decoded data block on which the SIC operation is executed for the second time is 0, determining that the decoded data block is decoded correctly, and no longer executing an SIC operation; and if the CRC of the decoded data block on which the SIC operation is executed for the second time is not 0, determining that the decoded data block is decoded incorrectly, no longer executing an SIC operation, and reporting a retransmission indication to the base station, so that the base station resends a downlink data signal.

Specifically, the terminal detects, by using the CRC detection mechanism of the terminal, CRCs of the decoded data blocks in the first decoded data block group and the second decoded data block group, to acquire the CRC of each decoded data block, and determines whether the CRC of each decoded data block is 0. When it is identified that the first decoded data block group and the second decoded data block group each include a decoded data block whose CRC is not 0, that is, the first decoded data block group and the second decoded data block group each include a decoded data block that is decoded incorrectly, the terminal performs an SIC operation for a first time on the decoded data blocks whose CRCs are not 0 in the first decoded data block group and the second decoded data block group. That is, herein, assuming that in the first decoded data block group, a CRC of the first decoded data block is 0 and a CRC of the fourth decoded data block is not 0, and that in the second decoded data block group, a CRC of the second decoded data block is 0, and a CRC of the third decoded data block group is not 0, in this case, the terminal performs a signal reconstruction operation on the first decoded data block and the second decoded data block, that is, performs encoding, constellation mapping processing, inter-layer interleaving, spreading and scrambling, and precoding operations on the first decoded data block and the second decoded data block, to construct a reconstructed signal (the inter-layer interleaving manner is described in Table 1.1), and before the four decoded data blocks enter the input end of the interleaving module shown in FIG. 2, the terminal further sets data streams of the fourth decoded data block and the third decoded data block to 0, so that the terminal can perform corresponding inter-layer interleaving. It should be noted that, the terminal only performs signal reconstruction on the decoded data blocks whose CRCs are 0. Then, the terminal subtracts the reconstructed signal from original data signals received by the terminal, where only original data signals corresponding to the third decoded data block and the fourth decoded data block whose CRCs are not 0 remain; performs a decoding preparation operation on the acquired original data signals corresponding to the third decoded data block and the fourth decoded data block, that is, performs LMMSE equalization, descrambling and despreading, inter-layer de-interleaving, and LLR operations (the inter-layer de-interleaving manner is described in Table 1.2), where the LMMSE equalization in the decoding preparation operation also uses n×4, which is the same as that in Embodiment 2, where n is determined according to a quantity of data streams actually existing in the received signal; and after all the foregoing operations are completed, decodes the data signals on which the decoding preparation operation is performed, to obtain the third decoded data block and the fourth decoded data block.

More specifically, there cases exist in continuing to perform CRC detection on the third decoded data block and the fourth decoded data block on which the SIC operation is executed for the first time:

a first case: if the CRCs of the third decoded data block and the fourth decoded data block on which the SIC operation is performed for the first time are both zero, it is determined that the two decoded data blocks are decoded correctly, and an SIC operation is no longer executed;

a second case: if neither of the CRCs of the third decoded data block and the fourth decoded data block on which the SIC operation is performed for the first time is zero, it is determined that the two decoded data blocks are decoded incorrectly, an SIC operation is no longer executed, and a retransmission indication is reported to the base station, so that the base station resends a downlink data signal; and

a third case: if the CRC of one of the third decoded data block and the fourth decoded data block on which the SIC operation is executed for the first time is not 0, herein assuming that the CRC of the third decoded data block is not zero, and the CRC of the fourth decoded data block is zero, executing an SIC operation on the third decoded data block for a second time includes: continuing to perform a signal reconstruction operation on the fourth decoded data block whose CRC is zero, that is, performing encoding, constellation mapping processing, inter-layer interleaving, spreading and scrambling, and precoding operations on the fourth decoded data block, to construct a reconstructed signal, and before the four decoded data blocks enter the input end of the interleaving module shown in FIG. 2, setting, by the terminal, a data stream of the third decoded data block whose CRC is not zero to 0, so that the terminal can perform corresponding inter-layer interleaving; then, subtracting the reconstructed signal from original data signals received by the terminal, where an original data signal corresponding to the third decoded data block whose CRC is not zero remains; performing a decoding preparation operation on the original data signal corresponding to the third decoded data block, that is, performing LMMSE equalization, descrambling and despreading, inter-layer de-interleaving, and LLR operations; and after all the foregoing operations are completed, decoding the data signal on which the decoding preparation operation is performed, to obtain the third decoded data block, and performing CRC detection on the decoded data block on which the SIC operation is executed for the second time. Herein, there are two cases: if the CRC of the third decoded data block on which the SIC operation is executed for the second time is 0, it is determined that the third decoded data block is decoded correctly, and an SIC operation is no longer executed; or if the CRC of the third decoded data block on which the SIC operation is executed for the second time is still not 0, that is, the CRC is the same as a CRC result, obtained through detection in the previous time, of the third decoded data block, it is determined that the third decoded data block is decoded incorrectly, an SIC operation is no longer executed, and a retransmission indication is reported to the base station, so that the base station resends a downlink data signal to the terminal

In the prior art, in a case in which the first decoded data block group and the second decoded data block group each include a decoded data block whose CRC is not 0, the terminal considers that none of CRCs of all decoded data blocks in the first decoded data block group and the second decoded data block group is 0, that is, all the decoded data blocks are decoded incorrectly, and the terminal no longer performs an SIC operation, but directly reports a retransmission indication to a base station, so that the base station re-delivers a data signal. However, in the present invention, a corresponding decoding operation is still performed on each decoded data block, to acquire correct downlink data, which improves a probability of correct decoding and lightens load of the base station.

In the method according to this embodiment, after CRC detection is performed on a decoded data block on which decoding is performed, an SIC operation is separately performed at least once on a decoded data block whose CRC is not 0, to ensure decoding accuracy, and only if none of CRCs of all decoded data blocks in a decoded data block group is 0, an indication of retransmitting downlink data is reported to a base station, thereby lightening load of the base station.

In Embodiment 6 of the present invention, on a basis of the foregoing embodiments, preferably, the separately performing CRC detection on each decoded data block, and determining, according to a CRC, obtained through detection, of each decoded data block, whether to execute a successive interference cancellation SIC operation, and if it is determined to execute an SIC operation, executing CRC detection again on the decoded data block on which an SIC operation is performed, until a same CRC result occurs or all CRCs are zero includes: separately performing CRC detection on each decoded data block, to acquire the CRC of each decoded data block; when it is identified that CRCs of decoded data blocks in one decoded data block group of the first decoded data block group and the second decoded data block group are all 0, and none of CRCs of the decoded data blocks in the other decoded data block group is 0, performing an SIC operation for a first time on the decoded data blocks whose CRCs are not 0; performing CRC detection on the decoded data blocks on which the SIC operation is executed for the first time; and if the CRCs of the decoded data blocks on which the SIC operation is executed for the first time are all 0, determining that the decoded data blocks are decoded correctly, and no longer executing an SIC operation; if none of the CRCs of the decoded data blocks on which the SIC operation is executed for the first time is 0, determining that the decoded data blocks are decoded incorrectly, no longer executing an SIC operation, and reporting a retransmission indication to the base station, so that the base station resends a downlink data signal; or if the CRC of one of the decoded data blocks on which the SIC operation is executed for the first time is not 0, executing an SIC operation for a second time on the decoded data block whose CRC is not 0; and if the CRC of the decoded data block on which the SIC operation is executed for the second time is 0, determining that the decoded data block is decoded correctly, and no longer executing an SIC operation; or if the CRC of the decoded data block on which the SIC operation is executed for the second time is not 0, determining that the decoded data block is decoded incorrectly, no longer executing an SIC operation, and reporting a retransmission indication to the base station, so that the base station resends a downlink data signal.

Specifically, the terminal detects, by using the CRC detection mechanism of the terminal, CRCs of the decoded data blocks in the first decoded data block group and the second decoded data block group, to acquire the CRC of each decoded data block, and determine whether the CRC of each decoded data block is 0; when it is identified that CRCs of decoded data blocks in one decoded data block group of the first decoded data block group and the second decoded data block group are all 0, and none of CRCs of the decoded data blocks in the other decoded data block group is 0, the terminal performs an SIC operation for a first time on the decoded data blocks whose CRCs are not 0. In this case, assuming that neither of the CRCs of the first decoded data block and the fourth decoded data block in the first decoded data block group is zero, and both CRCs of the second decoded data block and the third decoded data block in the second decoded data block group are zero, the terminal performs a signal reconstruction operation on the second decoded data block and the third decoded data block whose CRCs are zero, that is, performs encoding, constellation mapping processing, inter-layer interleaving, spreading and scrambling, precoding operations on the second decoded data block and the third decoded data block, to construct reconstructed signals (the inter-layer interleaving manner is described in Table 1.1), and before the four decoded data blocks enter the input end of the interleaving module shown in FIG. 2, the terminal further sets data streams of the first decoded data block and the fourth decoded data block to 0, so that the terminal can perform corresponding inter-layer interleaving. It should be noted that, the terminal only performs signal reconstruction on the decoded data blocks whose CRCs are 0. Then, the terminal subtracts the reconstructed signals of the second decoded data block and the third decoded data block from received original data signals, where only original data signals corresponding to the first decoded data block and the fourth decoded data block whose CRC is not 0 remain; performs a decoding preparation operation on the acquired original data signals corresponding to the first decoded data block and the fourth decoded data block, that is, performs LMMSE equalization, descrambling and despreading, inter-layer de-interleaving, and LLR operations (the inter-layer de-interleaving manner is described in Table 1.2), where the LMMSE equalization in the decoding preparation operation also uses n×4, which is the same as that in Embodiment 2, where n is determined according to a quantity of data streams actually existing in the received signal; and after all the foregoing operations are completed, decodes the data signals on which the decoding preparation operation is performed, to obtain the first decoded data block and the fourth decoded data block.

More specifically, there cases exist in continuing to perform CRC detection on the first decoded data block and the fourth decoded data block on which the SIC operation is executed for the first time:

a first case: if the CRCs of the first decoded data block and the fourth decoded data block on which the SIC operation is performed for the first time are both zero, it is determined that the two decoded data blocks are decoded correctly, and an SIC operation is no longer executed;

a second case: if neither of the CRCs of the first decoded data block and the fourth decoded data block on which the SIC operation is performed for the first time is zero, it is determined that the two decoded data blocks are decoded incorrectly, an SIC operation is no longer executed, and a retransmission indication is reported to the base station, so that the base station resends a downlink data signal; and

a third case: if the CRC of one of the first decoded data block and the fourth decoded data block on which the SIC operation is executed for the first time is not 0, herein assuming that the CRC of the first decoded data block is not zero, and the CRC of the fourth decoded data block is zero, executing an SIC operation on the first decoded data block for a second time includes: continuing, by a terminal, to perform a signal reconstruction operation on the fourth decoded data block whose CRC is zero, that is, performing encoding, constellation mapping processing, inter-layer interleaving, spreading and scrambling, and precoding operations on the fourth decoded data block, to construct a reconstructed signal, and before the four decoded data blocks enter the input end of the interleaving module shown in FIG. 2, setting, by the terminal, a data stream of the first decoded data block whose CRC is not zero to 0, so that the terminal can perform corresponding inter-layer interleaving; then, subtracting these reconstructed signals from original data signals received by the terminal, where an original data signal corresponding to the first decoded data block whose CRC is not zero remains; performing a decoding preparation operation on the original data signal corresponding to the first decoded data block, that is, performing LMMSE equalization, descrambling and despreading, inter-layer de-interleaving, and LLR operations; and after all the foregoing operations are completed, decoding the data signal on which the decoding preparation operation is performed, to obtain the first decoded data block, and performing CRC detection on the decoded data block on which the SIC operation is executed for the second time. Herein, there are two cases: if the CRC of the first decoded data block on which the SIC operation is executed for the second time is 0, it is determined that the first decoded data block is decoded correctly, and an SIC operation is no longer executed; or if the CRC of the first decoded data block on which the SIC operation is executed for the second time is still not 0, that is, the CRC is the same as a CRC result, obtained through detection in the previous time, of the first decoded data block, it is determined that the first decoded data block is decoded incorrectly, an SIC operation is no longer executed, and a retransmission indication is reported to the base station, so that the base station resends a downlink data signal to the terminal

Further, in all the foregoing embodiments, the inter-layer interleaving manner is the interleaving manner in Table 1.1, and the inter-layer de-interleaving manner is the de-interleaving manner in Table 1.2. Herein, for example, inter-layer interleaving is performed in a case in which the first decoded data block group includes a decoded data block whose CRC is not zero and another decoded data block whose CRC is zero:

Before inter-layer interleaving, data of the first decoded data block and the fourth decoded data block is distributed as follows:

the first decoded data block: d⁽⁰⁾(0) d⁽⁰⁾(1) d⁽⁰⁾(2) d⁽⁰⁾(3) d⁽⁰⁾(4) d⁽⁰⁾(5) . . . and the fourth decoded data block:

d⁽³⁾(0) d⁽³⁾(1) d⁽³⁾(2) d⁽³⁾(3) d⁽³⁾(4) d⁽³⁾(5) . . . .

After inter-layer interleaving is performed according to the manner in Table 1.1, data of the first decoded data block and the fourth decoded data block is distributed as follows:

Layer1 d⁽³⁾(0) d⁽⁰⁾(1) d⁽³⁾(2) d⁽⁰⁾(3) d⁽³⁾(4) d⁽⁰⁾(5) . . .

Layer4 d⁽⁰⁾(0) d⁽³⁾(1) d⁽⁰⁾(2) d⁽³⁾(3) d⁽⁰⁾(4) d⁽³⁾(5) . . .

Because inter-layer interleaving is used, the first decoded data block and the fourth decoded data block are distributed on a first layer and a fourth layer in an interleaved manner. In a transmission process, mutual interference, that is, inter-flow interference, is generated between the first layer and the fourth layer. If one decoded data block of the first decoded data block and the fourth decoded data block on which decoding is performed for a first time is decoded correctly, the terminal may subtract one decoded data block from the received signal. For example, if the first decoded data block is decoded correctly, the following signals may be obtained after the SIC operation is executed:

Layer1 d⁽³⁾(0) 0 d⁽³⁾(2) 0 d⁽³⁾(4) 0 . . .

Layer4 0 d⁽³⁾(1) 0 d⁽³⁾(3) 0 d⁽³⁾(5) . . .

It can be known the foregoing results that: inter-flow interference brought by the first decoded data block is removed from the fourth decoded data block, thereby improving a probability of correct decoding.

If the inter-layer interleaving manner in Table 1.1 is not used, a signal on the layers is as follows:

Layer1 d⁽⁰⁾(0) d⁽³⁾(0) d⁽⁰⁾(2) d⁽³⁾(2) d⁽⁰⁾(4) d⁽³⁾(4) . . .

Layer4 d⁽⁰⁾(1) d⁽³⁾(1) d⁽⁰⁾(3) d⁽³⁾(3) d⁽⁰⁾(5) d⁽³⁾(5) . . .

If the first decoded data block is decoded correctly, a signal on which an SIC operation is executed is as follows:

Layer1 0 d⁽³⁾(0) 0 d⁽³⁾(2) 0 d⁽³⁾(4) . . .

Layer4 0 d⁽³⁾(1) 0 d⁽³⁾(3) 0 d⁽³⁾(5) . . .

In this case, inter-flow interference in the fourth decoded data block is brought by the fourth decoded data block itself, and therefore, cancellation of the first decoded data block cannot weaken the inter-flow interference in the fourth decoded data block. Therefore, when the inter-layer interleaving manner in Table 1.1 is used, inter-flow interference brought by a decoded data block itself is avoided.

In the prior art, after signal reconstruction is performed for a first time to acquire a decoded data block whose CRC is not 0, an SIC operation is performed once on the decoded data block. If the three cases in the present invention also exist after an SIC operation is performed for a first time on a first decoded data block and a fourth decoded data block whose CRC is not 0, a difference lies in that, in the prior art, a retransmission indication is reported to a base station both in a case in which both the CRCs of the two decoded data blocks on which the foregoing operation is performed are not 0 and in a case in which one of the CRCs of the two decoded data blocks on which the foregoing operation is performed is not 0, but in the present invention, a retransmission indication is reported to a base station only in a case in which neither of the CRCs of the two decoded data blocks on which the foregoing operation is performed is 0, and in a case in which the CRC of one decoded data block of the two decoded data blocks on which the SIC operation is performed for the first time is not zero, an SIC operation is performed for a second time on the decoded data block whose CRC is not zero, to improve a probability of correct decoding and lighten load of the base station.

In the method according to this embodiment of the present invention, after CRC check detection is performed on a decoded data block on which decoding is performed, an SIC operation is separately performed at least once on a decoded data block whose CRC is not 0, to ensure decoding accuracy, and only in a case in which none of CRCs of all decoded data blocks in a decoded data block group is 0, an indication of retransmitting downlink data is reported to a base station, thereby lightening load of the base station.

Persons of ordinary skill in the art may understand that all or some of the steps of the method embodiments may be implemented by a program instructing related hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

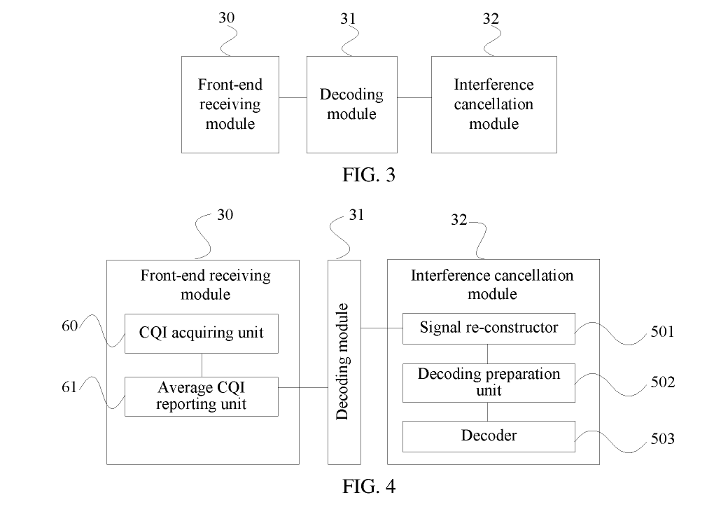

FIG. 3 is a schematic structural diagram of Embodiment 1 of a data receiving apparatus according to the present invention, and the apparatus may be integrated in a terminal. As shown in FIG. 3, the apparatus includes: a front-end receiving module 30, a decoding module 31, and an interference cancellation module 32, where the front-end receiving module 30 is configured to receive a data signal delivered by a base station, where the data signal includes at least two encoded data block groups, each encoded data block group includes at least one encoded data block, and encoded data blocks in each encoded data block group are transmitted in a binding manner; the decoding module 31 is configured to decode the data signal, and acquire decoded data blocks obtained by decoding the encoded data blocks, to form corresponding decoded data block groups; and the interference cancellation module 32 is configured to separately perform cyclic redundancy check CRC detection on each decoded data block, and determine, according to a CRC, obtained through detection, of each decoded data block, whether to execute a successive interference cancellation SIC operation, and if it is determined to execute an SIC operation, execute CRC detection again on the decoded data block on which an SIC operation is performed, until a same CRC result occurs or all CRCs are zero, where at least one of the determining to execute an SIC operation according to the CRC of each decoded data block includes: when CRCs of some decoded data blocks belonging to a decoded data block group are not zero, determining that the decoded data block is decoded incorrectly, and executing an SIC operation on the decoded data block.

The data receiving apparatus of this embodiment may execute the foregoing Embodiment 1 of the data receiving method, implementation principles and technical effects thereof are similar, and details are not described again herein.

FIG. 4 is a schematic structural diagram of Embodiment 2 of a data receiving apparatus according to the present invention, and on a basis of the embodiment shown in FIG. 3, the interference cancellation module 32 is specifically configured to: identify whether the CRC of each decoded data block is zero; and when it is identified that the CRCs of all the decoded data blocks are all zero, determine that the decoded data blocks are decoded correctly, and skip executing an SIC operation; or when it is identified that not all of the CRCs of the decoded data blocks are zero, identify whether a CRC result of each decoded data block is the same as a previous CRC result; and if yes, determine that the decoded data block is decoded incorrectly, skip executing an SIC operation, and report a retransmission indication to the base station, so that the base station resends a downlink data signal; or if no, determine that the decoded data block is decoded incorrectly, and execute an SIC operation.

The data receiving apparatus of this embodiment may execute the foregoing Embodiment 2 of the data receiving method, implementation principles and technical effects thereof are similar, and details are not described again herein.

Further, on a basis of the foregoing embodiment shown in FIG. 4, the interference cancellation module 32 includes: a signal re-constructor 501, configured to: when not all of the CRCs of the decoded data blocks are zero, separately perform a signal reconstruction operation on a decoded data block whose CRC is zero, to acquire a reconstructed signal of each decoded data block; and subtract the reconstructed signal of each decoded data block from the received data signal, to acquire an original data signal corresponding to a decoded data block whose CRC is not zero; a decoding preparation unit 502, configured to perform a decoding preparation operation on the acquired original data signal; and a decoder 503, configured to decode the data signal on which the decoding preparation operation is performed, to obtain a decoded data block, where the decoding preparation unit 502 is specifically configured to perform LMMSE equalization, descrambling and despreading, inter-layer de-interleaving, and a LLR calculation on the acquired original data signal.

The data receiving apparatus of this embodiment may execute the foregoing Embodiment 3 of the data receiving method, implementation principles and technical effects thereof are similar, and details are not described again herein.

Further, on a basis of the foregoing embodiment shown in FIG. 4, the front-end receiving module 30 may further include: a CQI acquiring unit 60, configured to: before the data signal delivered by the base station is received, separately acquire physical channel quality corresponding to each encoded data block group, to determine an average CQI of each encoded data block group; and an average CQI reporting unit 61, configured to report the average CQI to the base station, so that the base station determines, according to the average CQI, a size of the encoded data block of the delivered data signal.

The data receiving apparatus of this embodiment may execute the foregoing Embodiment 4 of the data receiving method, implementation principles and technical effects thereof are similar, and details are not described again herein.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A data receiving method, comprising:
receiving a data signal delivered by a base station, wherein the data signal comprises at least two encoded data block groups, each encoded data block group comprises at least one encoded data block, and encoded data blocks in each encoded data block group are transmitted in a binding manner;
decoding the data signal, and acquiring decoded data blocks obtained by decoding the encoded data blocks, to form corresponding decoded data block groups; and
separately performing cyclic redundancy check (CRC) detection on each decoded data block, and determining, according to a CRC, obtained through detection, of each decoded data block, whether to execute a successive interference cancellation (SIC) operation, and if it is determined to execute an SIC operation, executing CRC detection again on the decoded data block on which an SIC operation is performed, until a same CRC result occurs or all CRCs are zero, wherein
at least one of the determining to execute an SIC operation according to the CRC of each decoded data block comprises: when CRCs of some decoded data blocks belonging to a decoded data block group are not zero, determining that the decoded data block is decoded incorrectly, and executing an SIC operation on the decoded data block.

2. The method according to claim 1, wherein the determining, according to a CRC, obtained through detection, of each decoded data block, whether to execute an SIC operation comprises:
identifying whether CRCs of all decoded data blocks are zero; and
when it is identified that the CRCs of all the decoded data blocks are all zero, determining that the decoded data blocks are decoded correctly, and skipping executing an SIC operation; or
when it is identified that not all of the CRCs of the decoded data blocks are zero, identifying whether a CRC result of each decoded data block is the same as a previous CRC result; and if the CRC result of each decoded data block is the same as the previous CRC result, determining that the decoded data block is decoded incorrectly, skipping executing an SIC operation, and reporting a retransmission indication to the base station, so that the base station resends a downlink data signal; or if the CRC result of each decoded data block is not the same as the previous CRC result, determining that the decoded data block is decoded incorrectly, and executing an SIC operation.

3. The method according to claim 2, wherein the when it is identified that the CRC result of each decoded data block is not the same as the previous CRC result, determining that the decoded data block is decoded incorrectly, and executing an SIC operation comprises:
when the CRC result of each decoded data block is not the same as the previous CRC result, separately performing a signal reconstruction operation on a decoded data block whose CRC is zero, to acquire a reconstructed signal of the decoded data block;
subtracting the reconstructed signal of the decoded data block from the received data signal, to acquire an original data signal corresponding to a decoded data block whose CRC is not zero;
performing a decoding preparation operation on the acquired original data signal; and
decoding the data signal on which the decoding preparation operation is performed, to obtain a decoded data block.

4. The method according to claim 3, wherein the performing a decoding preparation operation on the acquired original data signal comprises:
performing linear minimum mean square error (LMMSE) equalization, descrambling and despreading, inter-layer de-interleaving, and a log-likelihood ratio (LLR) calculation on the acquired original data signal.

5. The method according to claim 1, before the receiving a data signal delivered by a base station, further comprising:
separately acquiring physical channel quality corresponding to each encoded data block group, to determine an average channel quality indicator (CQI) of each encoded data block group; and
reporting the average CQI to the base station, so that the base station determines, according to the average CQI, a size of the encoded data block of the delivered data signal.

6. The method according to claim 1, wherein if a quantity of the decoded data block groups is two, the decoding the data signal, and acquiring decoded data blocks comprises:
decoding the data signal, and acquiring a first decoded data block group and a second decoded data block group, wherein the first decoded data block group comprises: a first decoded data block and a fourth decoded data block, and the second decoded data block group comprises: a second decoded data block and a third decoded data block, wherein the first decoded data block and the fourth decoded data block are transmitted in a binding manner, and the second decoded data block and the third decoded data block are transmitted in a binding manner.

7. The method according to claim 6, wherein the separately performing CRC detection on each decoded data block, and determining, according to a CRC, obtained through detection, of each decoded data block, whether to execute a successive interference cancellation SIC operation, and if it is determined to execute an SIC operation, executing CRC detection again on the decoded data block on which an SIC operation is performed, until a same CRC result occurs or all CRCs are zero comprises:
separately performing CRC detection on each decoded data block, to acquire the CRC of each decoded data block;
when it is identified that the first decoded data block group and the second decoded data block group each comprise a decoded data block whose CRC is not 0, performing an SIC operation for a first time on the decoded data blocks whose CRCs are not 0 in the first decoded data block group and the second decoded data block group;
performing CRC detection on the decoded data blocks on which the SIC operation is executed for the first time; and
if the CRCs of the decoded data blocks whose CRCs are not 0 in the first decoded data block group and the second decoded data block group are both 0 after undergoing the SIC operation for the first time, determining that the decoded data blocks are decoded correctly, and no longer executing an SIC operation;
if neither of the CRCs of the decoded data blocks on which the SIC operation is executed for the first time is 0, determining that the decoded data blocks are decoded incorrectly, no longer executing an SIC operation, and reporting a retransmission indication to the base station, so that the base station resends a downlink data signal; or
if the CRC of one of the decoded data blocks on which the SIC operation is executed for the first time is not 0, determining that the decoded data block is decoded incorrectly, and executing an SIC operation for a second time on the decoded data block whose CRC is not 0;
performing CRC detection on the decoded data block on which the SIC operation is executed for the second time; and
if the CRC of the decoded data block on which the SIC operation is executed for the second time is 0, determining that the decoded data block is decoded correctly, and no longer executing an SIC operation; or
if the CRC of the decoded data block on which the SIC operation is executed for the second time is not 0, determining that the decoded data block is decoded incorrectly, no longer executing an SIC operation, and reporting a retransmission indication to the base station, so that the base station resends a downlink data signal.

8. The method according to claim 6, wherein the separately performing CRC detection on each decoded data block, and determining, according to a CRC, obtained through detection, of each decoded data block, whether to execute a successive interference cancellation SIC operation, and if it is determined to execute an SIC operation, executing CRC detection again on the decoded data block on which an SIC operation is performed, until a same CRC result occurs or all CRCs are zero comprises:
separately performing CRC detection on each decoded data block, to acquire the CRC of each decoded data block;
when it is identified that all CRCs of decoded data blocks in one decoded data block group of the first decoded data block group and the second decoded data block group are all 0, and none of CRCs of decoded data blocks in the other decoded data block group is 0, performing an SIC operation for a first time on the decoded data blocks whose CRCs are not 0;
performing CRC detection on the decoded data blocks on which the SIC operation is executed for the first time; and
if the CRCs of all the decoded data blocks on which the SIC operation is executed for the first time are all 0, determining that the decoded data blocks are decoded correctly, and no longer executing an SIC operation;
if none of the CRCs of the decoded data blocks on which the SIC operation is executed for the first time is 0, determining that the decoded data block is decoded incorrectly, no longer executing an SIC operation, and reporting a retransmission indication to the base station, so that the base station resends a downlink data signal; or
if the CRC of one of the decoded data blocks on which the SIC operation is executed for the first time is not 0, executing an SIC operation for a second time on the decoded data block whose CRC is not 0; and
if the CRC of the decoded data block on which the SIC operation is executed for the second time is 0, determining that the decoded data block is decoded correctly, and no longer executing an SIC operation; or
if the CRC of the decoded data block on which the SIC operation is executed for the second time is not 0, determining that the decoded data block is decoded incorrectly, no longer executing an SIC operation, and reporting a retransmission indication to the base station, so that the base station resends a downlink data signal.

9. A data receiving apparatus, comprising:
a front-end receiving module, configured to receive a data signal delivered by a base station, wherein the data signal comprises at least two encoded data block groups, each encoded data block group comprises at least one encoded data block, and encoded data blocks in each encoded data block group are transmitted in a binding manner;
a decoding module, configured to decode the data signal, and acquire decoded data blocks obtained by decoding the encoded data blocks, to form corresponding decoded data block groups; and
an interference cancellation module, configured to: separately perform cyclic redundancy check (CRC) detection on each decoded data block, and determine, according to a CRC, obtained through detection, of each decoded data block, whether to execute a successive interference cancellation (SIC) operation, and if it is determined to execute an SIC operation, execute CRC detection again on the decoded data block on which an SIC operation is performed, until a same CRC result occurs or all CRCs are zero, wherein at least one of the determining to execute an SIC operation according to the CRC of each decoded data block comprises: when CRCs of some decoded data blocks belonging to a decoded data block group are not zero, determining that the decoded data block is decoded incorrectly, and executing an SIC operation on the decoded data block.

10. The apparatus according to claim 9, wherein the interference cancellation module is specifically configured to: identify whether the CRC of each decoded data block is zero; and when it is identified that the CRCs of all the decoded data blocks are all zero, determine that the decoded data blocks are decoded correctly, and skip executing an SIC operation; or when it is identified that not all of the CRCs of the decoded data blocks are zero, identify whether a CRC result of each decoded data block is the same as a previous CRC result; and if the CRC result of each decoded data block is the same as the previous CRC result, determine that the decoded data block is decoded incorrectly, skip executing an SIC operation, and report a retransmission indication to the base station, so that the base station resends a downlink data signal; or if the CRC result of each decoded data block is not the same as the previous CRC result, determine that the decoded data block is decoded incorrectly, and execute an SIC operation.

11. The apparatus according to claim 10, wherein the interference cancellation module comprises:
a signal re-constructor, configured to: when the CRC result of each decoded data block is not the same as the previous CRC result, separately perform a signal reconstruction operation on a decoded data block whose CRC is zero, to acquire a reconstructed signal of each decoded data block; and subtract the reconstructed signal of the decoded data block from the received data signal, to acquire an original data signal corresponding to a decoded data block whose CRC is not zero;
a decoding preparation unit, configured to perform a decoding preparation operation on the acquired original data signal; and
a decoder, configured to decode the data signal on which the decoding preparation operation is performed, to obtain a decoded data block.

12. The apparatus according to claim 11, wherein the decoding preparation unit is specifically configured to perform linear minimum mean square error (LMMSE) equalization, descrambling and despreading, inter-layer de-interleaving, and a log-likelihood ratio (LLR) calculation on the acquired original data signal.

13. The apparatus according to claim 9, wherein the front-end receiving module further comprises:
a channel quality indicator (CQI) acquiring unit, configured to: before the data signal delivered by the base station is received, separately acquire physical channel quality corresponding to each encoded data block group, to determine an average CQI of each encoded data block group; and
an average CQI reporting unit, configured to report the average CQI to the base station, so that the base station determines, according to the average CQI, a size of the encoded data block of the delivered data signal.

14. The apparatus according to claim 9, wherein if a quantity of the decoded data block groups is two, the decoding module is specifically configured to: decode the data signal, and acquire a first decoded data block group and a second decoded data block group, wherein the first decoded data block group comprises: a first decoded data block and a fourth decoded data block, and the second decoded data block group comprises: a second decoded data block and a third decoded data block, wherein the first decoded data block and the fourth decoded data block are transmitted in a binding manner, and the second decoded data block and the third decoded data block are transmitted in a binding manner.
